(19) United States
(12) Patent Application Publication
(10) Pub. No.: US 2026/0329095 A1
(43) Pub. Date: Oct. 22, 2026

(54) HEAD-MOUNTABLE DEVICE

(71) Applicant: Apple Inc., Cupertino, CA (US)

(72) Inventors: Nivay Anandarajah, San Jose, CA (US); Darshan R Kasar, Redwood City, CA (US); Liam R Martinez, San Francisco, CA (US); Nawaf Al-Baghly, San Jose, CA (US)

(21) Appl. No.: 19/313,462

(22) Filed: Aug. 28, 2025

Related U.S. Application Data
(60) Provisional application No. 63/792,770, filed on Apr. 22, 2025.

(51) Int. Cl. G02B 27/01; G02C 11/00

(52) U.S. Cl. CPC G02B 27/0176; G02C 11/10; G02B 2027/0178

(57) ABSTRACT

A head-mountable device can include a frame defining a first portion and a housing defining an internal frame volume, a display window coupled to the frame, an internal component disposed within the internal frame volume, and a material dam coupled to the first portion and defining a boundary between the internal frame volume and the first portion.

### CROSS-REFERENCE TO RELATED APPLICATION

This application claims the benefit of U.S. Provisional Application No. 63/792,770, filed 22 Apr. 2025, entitled “HEAD-MOUNTABLE DEVICE,” the entire disclosure of which is hereby incorporated by reference.

### FIELD

The present disclosure relates generally to wearable display devices. More particularly, the present disclosure relates to head-mountable devices with integrated electronics.

### BACKGROUND

Various components of wearable display devices, such as head-mountable devices (HMD), can include as display screens, viewing frames, securement arms, speakers, batteries, waveguides, and other components, which operate together to provide an immersive experience to the user. However, the number and location of components that can be integrated into the head-mountable device can be limited in order to maintain an appropriate weight of the wearable display device for a user's head. The miniaturization and reduction of components while maintaining or increasing device functionality can give rise to manufacturing and assembly challenges. Therefore, what is needed in the art are head-mountable devices including improved manufacturing techniques and components positioned and arranged together in compact, light-weight configurations without sacrificing overall device functionality.

### SUMMARY

At least one example of the present disclosure includes a head-mountable device including a frame defining a first portion and a housing defining an internal frame volume, a display window coupled to the frame, an internal component disposed within the internal frame volume, and a material dam coupled to the first portion and defining a boundary between the internal frame volume and the first portion.

In one example, the frame can include a first material, and the material dam can include the first material. In one example, the frame can include a first material, and the material dam can include a second material. In one example, the internal component can be at least one of a speaker, a charging module, a camera, a gyroscope, or an LED. In one example, the head-mountable device can include an electrical interconnect extending from the internal component to a second component through the boundary. In one example, the frame can define the housing proximal a nasal region or a temple region of a user donning the head-mountable device. In one example, the head-mountable device can include a securement arm, and the housing can be positioned between the frame and the securement arm. In one example, the housing and the material dam can define the internal volume configured to receive the internal component.

In at least one example of the present disclosure, a head-mountable device includes a frame defining an internal component cavity and a channel extending toward the internal component cavity, an optical module coupled to the frame, an internal component configured to be received by the internal component cavity, a dam separating the channel and internal component cavity, and a flex including a cantilever portion at a distal end of the flex. The flex extends through the channel, the cantilever portion extends into the internal component cavity, the cantilever portion is surrounded by the dam, and the internal component is configured to couple to the cantilever portion.

In one example, the cantilever portion can be configured to bend up to about 90 degrees relative to the dam. In one example, the cantilever portion can be configured to partially enclose the internal component within the internal component cavity. In one example, the internal component can be configured to electrically couple to the cantilever portion. In one example, the internal component can be a first internal component, and the head-mountable device can include a second internal component coupled to the first internal component. In one example, the dam can include a first material, and the channel can be filled with the first material. In one example, the head-mountable device can include a cover configured to couple to the internal component housing and define the internal cavity. In one example, the cantilever portion can include a circuit board.

In at least one example of the present disclosure, a wearable display device includes a frame defining an internal channel, an optical frame coupled to the frame, an electrical interconnect extending through the channel, a component housing configured to couple to the frame, and an internal component disposed in the component housing and configured to electrically couple to the interconnect. The component housing can include an internal component configured to electrically couple to the interconnect.

In one example, the component housing can include an insulating material. In one example, the component housing can include an internal cavity configured to receive the internal component, and a component interconnect configured to electrically couple the internal component to the electrical interconnect, the electrical interconnect can extend from the internal cavity to an exterior of the component housing. In one example, the component housing can include a cover configured to enclose the internal component within the component housing.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 illustrates a perspective view of one example of a head-mountable device;

FIG. 2 illustrates a perspective close-up view of one example of a head-mountable device;

FIG. 3A illustrates a side close-up view of one example of a head-mountable device;

FIG. 3B illustrates a front close-up view of one example of a head-mountable device;

FIG. 3C illustrates a close-up cross-sectional view of one example of a head-mountable device;

FIG. 4 illustrates a front close-up view of one example of a head-mountable device; and

FIG. 5 illustrates a close-up cross-sectional view of one example of a head-mountable device.

### DETAILED DESCRIPTION

Reference will now be made in detail to representative examples illustrated in the accompanying drawings. It should be understood that the following descriptions are not intended to limit the examples to one preferred example. To the contrary, it is intended to cover alternatives, modifications, and equivalents as can be included within the spirit and scope of the described embodiments as defined by the appended claims.

The present disclosure relates to electronic devices. More particularly, the present disclose relates to wearable electronic devices. Various components of wearable electronic devices, such as head-mountable devices (HMD), can include as display screens, viewing frames, securement arms, speakers, batteries, waveguides, and other components, which operate together to provide an immersive experience. Wearable display devices include a variety of components operating together to provide an immersive experience. The number and location of components integrated into the head-mountable device can be minimized to maintain a comfortable weight for a user's head. The reduction in the number of component and the miniaturized integration within the device can present manufacturing and assembly challenges. The present disclosure includes devices having various components integrated into various areas or regions of the head-mountable device that provide compact and light-weight products while simplifying manufacturing and protecting components during manufacturing and assembly.

Examples of head-mountable devices described herein can include optical devices, for example glasses lenses, goggles with lenses, transparent display windows, display screens or virtual/augmented reality devices that can include optical components. In these examples, the head-mountable device can be donned on the head of a user such that optically transparent widows, for example lenses and transparent optical displays, can be positioned in front of a user's eyes. The frame can encompass many of the components needed for operation. However, components can be sensitive to temperature, pressure, or both, thus creating challenges when manufacturing the frame with the embedded components. To protect the components during manufacturing, the components can be added after the frame is created or encased or overmolded in a protective housing.

In one example, the frame can include an internal component housing. The internal component housing can be configured to receive the components after the frame is created. In one example, the internal component housing can include a material dam, or boundary, configured to maintain an internal cavity for the internal component when a frame is created, or an internal channel of the frame is filled. In one example, the dam protects the internal components. In one example, the dam maintains the internal cavity of the internal component housing such that the internal component can be inserted. In one example, an interconnect or flex extends from the channel into the internal cavity and is secured by the dam. Thus, a distal portion of the flex creates a cantilever portion. The cantilever portion can be configured to rotate out of the internal cavity to couple one or more internal components. The cantilever portion can rotate back into the internal cavity, such that the internal components are enclosed in the internal component housing. In one example, the internal components can be potted in the internal component housing, such that the internal component and the internal component housing create a pod that can be attached to the frame. In one example, the frame can be created using any process, and the pod can be coupled after creation to protect the internal components.

In this way, the various functional components of head-mountable devices can be integrated into the frame seamlessly and without incurring damage during the manufacturing process. The resulting component configuration provides light-weight, highly functional devices.

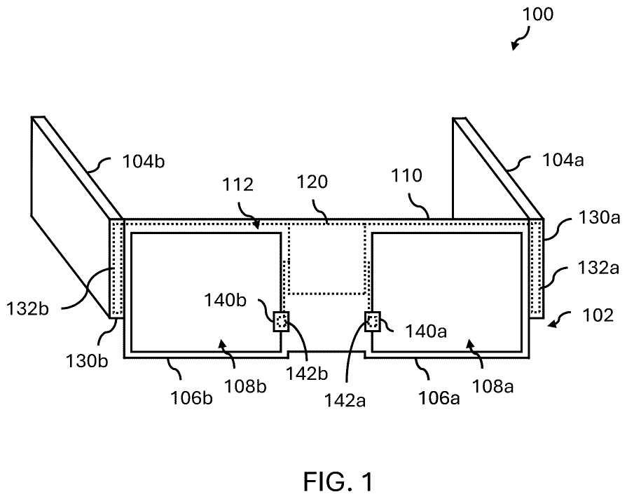

These and other embodiments are discussed below with reference to FIGS. 1-5. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a perspective view of one example of a head-mountable device 100. The head-mountable device (HMD) 100 can be any device or system configured to be worn on the head of a user, such as an optical device, smart glasses, alternate/virtual reality goggles, and the like. As shown in FIG. 1, the device 100 can include at least one frame 102. The frame 102 can include securement arms 104a-b, optical frames 106a-b, and a frame body 110.

The head-mountable device 100 can include one or more securement arms 104a and 104b. The securement arms 104a-b can be coupled to the frame body 110. In one example, the securement arms 104a-b can extend from the frame body 110. The securement arms 104a-b can be integrated into the frame body 110. The securement arms 104a-b can be configured to support the head-mountable device 100 on the head of a user. In one example, the securement arms 104a-b can be configured to support the head-mountable device 100 on the ears of the user. The securement arms 104a-b can be configured to extend around the head of the user to support the head-mountable device 100.

Optical frames 106a-b can include a first window 108a and a second window 108b coupled to the frame body 110. The first and second windows 108a-b, and other windows shown in other figures and described herein, can include transparent windows without corrective vision properties. The windows 108a-b described herein can also include corrective vision features. The windows 108a-b described herein can be configured next to displays to transmit and/or direct light from the displays to the eyes of the user. While windows 108a-b are used as an example in the present disclosure, the windows 108a-b can be one of a number of components of a display assembly including other components noted above, for example display screens, display support structures, and so forth. In one or more examples, the windows 108a-b can include optically transparent display windows, display screens, transparent material, optical lenses, lenses, or transparent display screens, or combinations thereof, in front of the eyes of the user, and can include corrective vision and non-corrective vision properties.

In at least one example, the frame body 110 can be configured to secure a display window, display screen, windows, and/or lenses configured to present visual information to the user. The frame body 110 can be configured to house a variety of components and systems. The frame body 110 can define an internal cavity 112. In one example, the internal cavity 112 can extend throughout the frame body 110. In one example, the internal cavity 112 can extend through a portion of the frame body 110. The internal cavity 112 can be configured to house internal components, couple external components, facilitate connections between components, or a combination thereof.

The head-mountable device 100 can include internal components 120. Internal components can include power sources, batteries, processors, cameras, gyroscopes, lights, speakers, microphones, and the like. The internal components 120 can be positioned in a central region of the frame body 110. For example, the internal components 120 can be positioned between the optical frames 106a and 106b. The internal components 120 can be connected throughout the frame body 110. As FIG. 1 illustrates, the internal components 120 can include frame components 132a-b and nasal components 142a-b.

The frame body 110 can define, include, or couple frame component housings 130a-b. In one example, the frame component housings 130a-b can couple to the optical frames 106a-b. The frame component housings 130a-b can be positioned on the frame body 110. In one example, the frame component housings 130a-b can be positioned near a temple region of the frame body 110. In one example, the frame component housings 130a-b can be positioned proximal the securement arms 104a-b. The frame component housings 130a-b can be configured to receive or include internal components, such as frame components 132a-b. The frame components 132a-b can include power sources, batteries, processors, cameras, gyroscopes, lights, speakers, microphones, and the like. In one example, the frame components 132a-b can include attachment components for the securement arms 104a-b.

The frame body 110 can define, include, or couple nasal component housings 140a-b. The nasal component housings 140a-b can be positioned on the frame body 110. In one example, the nasal component housings 140a-b can be positioned near a nasal or nose region of the frame body 110. In one example, the nasal component housings 140a-b can be positioned proximal the optical frames 106a-b. The nasal component housing 140a-b can be coupled to the optical frames 106a-b. The nasal component housings 140a-b can be configured to receive or include internal components, such as nasal components 142a-b. The nasal components 142a-b can include power sources, batteries, processors, cameras, gyroscopes, lights, speakers, microphones, and the like.

Any of the features, components, and/or parts, of the head-mountable device 100 including the arrangements and configurations thereof shown in FIG. 1 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 1.

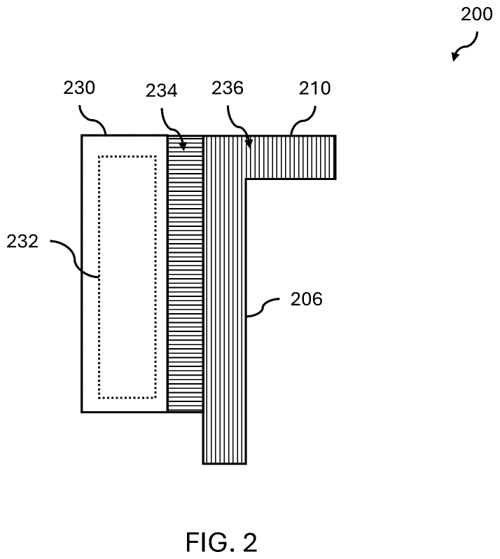

FIG. 2 illustrates a perspective close-up view of one example of a head-mountable device 200. The head-mountable device 200 can include a frame body 210, an optical frame 206, and a frame component housing 230. The frame body 210 can be substantially similar to the frame body 110. The frame body 210 can include a frame rear housing, a frame front housing, and a material 236 filling an interior cavity of the frame body 110. The frame body 210 can be created by forming the rear housing, adding the material 236 to fill around internal component, and forming the front housing. The material 236 can be added using a low injection pressure over molding process. In one example, the material 236 can include plastic, nylon plastic, a thermoplastic polyamide resin, and the like.

The optical frame 206 can be coupled to the frame body 210. In one example, the optical frame 206 can be defined by the frame body 210. The optical frame 206 can be integrated into the frame body 210. The optical frame 206 can be substantially similar to the optical frames 106a-b.

The frame component housing 230 can be coupled to the frame body 210. In one example, the frame component housing 230 can be defined by the frame body 210. The frame component housing 230 can be integrated into the frame body 210. The frame component housing 230 can be substantially similar to the frame component housings 130a-b. The frame component housing 230 can be configured to house a frame component 232. In one example, the frame component housing 230 can define an internal cavity to house the frame component 232. The frame component 232 can include power sources, batteries, processors, cameras, gyroscopes, lights, speakers, microphones, and the like. The frame component 232 can include an electrical coupling for components housed in securement arms of the head-mountable device 200. The frame component 232 can be sensitive to temperature, pressure, or a combination thereof.

The frame component housing 230 can include a material dam 234 separating the frame component 232 from the frame body 210. In one example, the dam 234 creates a boundary between the frame component housing 230 and the frame body 210. In one example, the dam 234 can extend between the frame component housing 230 and the frame body 210. In one example, the dam 234 can fill an internal cavity connecting an internal cavity of the frame component housing 230 and an internal cavity of the frame body 110. The dam 234 can define a portion of the internal cavity.

The dam 234 can be configured to protect the frame component 232 during the manufacturing process to form the frame body 110. For example, the manufacturing process for the frame body 110 can include high temperature, high pressure, or a combination thereof. In one example, the dam 234 can protect the frame component 232 from the material 236 of the frame body 110, such as when the material 236 is in a high-temperature or high-pressure flowable state during manufacturing. The dam 234 can be configured to provide thermal insulation of the frame component 232, or the internal cavity for the frame component 232. For example, the dam 234, or the frame component housing 230 can include a thermally insulating material. In one example, the dam 234 can extend around the frame component 232. The dam 234 can be configured to secure the frame component 232 in place and therefor protect the frame component 234 from damage or movement if the head-mountable device 200 is dropped or encounters other unintended forces.

In one example, the dam 234 can be created before the frame body 210. The dam 234 can be an adhesive, epoxy, plastic, or other flowable material. In one example, the dam 234 can be created using a low injection pressure over molding process. In one example, the frame component 232 can be added after the dam 234 is created. The dam 234 can be configured to expose connection points for adding the frame component 232. In one example, the frame component 232 can be added before the dam 234 is created.

Any of the features, components, and/or parts, of the head-mountable device 200 including the arrangements and configurations thereof shown in FIG. 2 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 2.

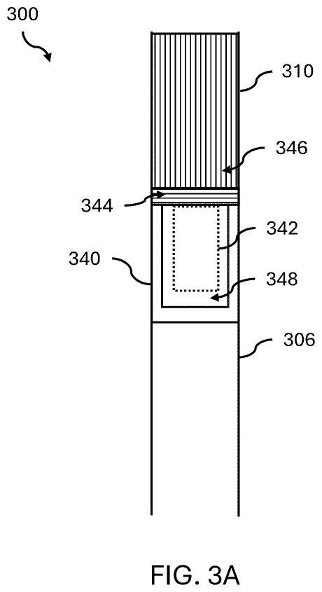

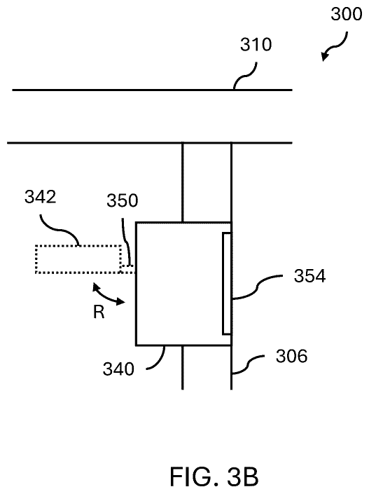

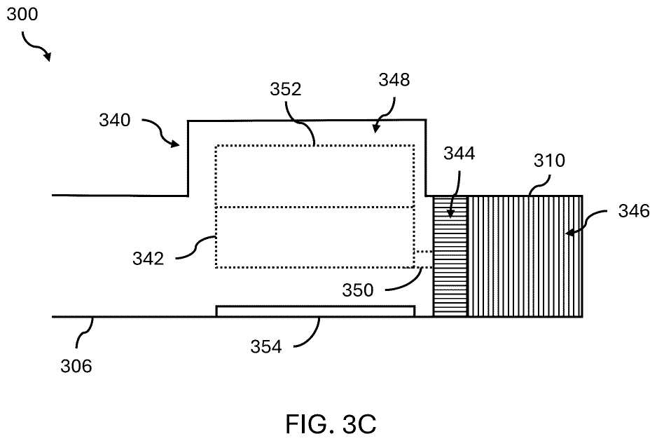

FIGS. 3A-3C illustrates various views of one example of a head-mountable device 300. The head-mountable device 300 can include a frame body 310, an optical frame 306, and a nasal component housing 340. The frame body 310 can be substantially similar to the frame body 110 and 210. The frame body 310 can comprise a frame rear housing, a frame front housing, and a material 346 filling an interior cavity of the frame body 310. The frame body 310 can be created by creating the rear housing, adding the material 346 to fill around internal component, and creating the front housing. The material 346 can be added using a low injection pressure over molding process. In one example, the material 346 can include plastic, nylon plastic, a thermoplastic polyamide resin, and the like.

The optical frame 306 can be coupled to the frame body 310. In one example, the optical frame 306 can be defined by the frame body 310. The optical frame 306 can be integrated into the frame body 310. The optical frame 306 can be substantially similar to the optical frames 106a-b and 206.

The nasal component housing 340 can be coupled to the optical frame 306. In one example, the nasal component housing 340 can be defined by the optical frame 306. In one example, the nasal component housing 340 can be integrated into the optical frame 306. In one example, the nasal component housing 340 can be coupled to, defined by, or integrated into the frame body 310. The nasal component housing 340 can be substantially similar to the nasal component housing 140a-b. The nasal component housing 340 can be configured to house a nasal component 342. In one example, the nasal component housing 340 can define an internal cavity 348 to house the nasal component 342. The nasal component 342 can include power sources, batteries, processors, cameras, internal facing cameras, gyroscopes, lights, speakers, microphones, and the like. The nasal component 342 can be sensitive to temperature, pressure, or a combination thereof.

The nasal component housing 340 can include a dam 344 separating the nasal component 342 from the frame body 310. In one example, the dam 344 creates a boundary between the nasal component housing 340 and the frame body 310. In one example, the dam 344 can extend between the nasal component housing 340 and the frame body 310. In one example, the dam 344 can fill an internal cavity connecting the internal cavity 348 of the nasal component housing 340 and an internal cavity of the frame body 310. The dam 344 can define a portion of the internal cavity of the frame body 310 or the internal cavity 248 of the nasal component housing 340. The dam 344 can be configured to protect the nasal component 342 from the frame body 310. In one example, the dam 344 can protect the nasal component 342 from the material 346 of the frame body 310. The dam 344 can be configured to secure the nasal component 342 in place. The dam 344 can be configured to provide thermal insulation of the nasal component 342, or the internal cavity 348 for the nasal component 342. In one example, the dam 344 can extend around the nasal component 342.

In one example, the dam 344 can be created before the frame body 310. The dam 344 can be an adhesive, epoxy, plastic, or other flowable material. In one example, the dam 344 can be created using a low injection pressure over molding process. In one example, the nasal component 342 can be added after the dam 344 is created. The dam 344 can be configured to expose connection points for adding the nasal component 342. In one example, the nasal component 342 can be added before the dam 344 is created.

The nasal component 342 can couple to other internal components of the device 300 via an electrical flex 350. The electrical flex 350 can include a flexible printed circuit or other flexible electrical conductor. The flex 350 can extend from the nasal component 342 toward the frame body 310. In one example, the flex 350 can be secured in position by the dam 344. The flex 350 can be an interconnect, or a portion of an interconnection system.

The nasal component housing 340 can include a nasal pad 354. The nasal pad 354 can be configured to face the nose of a user. The nasal pad 354 can define a boundary of the internal cavity 348. The nasal pad 354 can be configured to be attached to the optical frame 306 after the internal component 342 is added to the internal cavity 348. In one example, the nasal pad 354 can be received in an aperture of the nasal component housing 340. The aperture of the nasal component housing 340 can be configured to allow the flex 350 to cause the internal component 342 to extend outside the internal cavity 342. The nasal pad 354 can be adhered to the nasal component housing 340, the optical frame 306, or a combination thereof.

As illustrated in FIG. 3B, the flex 350 can be configured to rotate as indicated by arrows R. In one example, the flex 350 creates a cantilever. The flex 350 can be configured to cantilever out through an aperture of the optical frame 306, the nasal component housing 340, or the nasal pad 354. When the flex 350 cantilevers and extends out the internal cavity 348, the nasal component 342 can receive a second component 352. For example, the nasal component 342 can be a flexible circuit board such that a second component 352 can be attached to the flexible circuit board 350 and received by the internal cavity 348 when rotated (arrows R) back into the nasal component housing 340. In one example, the second component 352 can be a camera, an inward facing camera, an LED, a gyroscope, an inertial measurement unit, a printed circuit board, or a combination thereof. In one example, the nasal component 342 and the second component 352 can be secured into the nasal component housing 340 with adhesive after being inserted. In one example, adhesive can be added to the internal cavity 348, then the nasal component 342 and the second component 352 can be inserted into the nasal component housing 340, then the adhesive can be cured to secure the nasal component 342 and the second component 352. In one example, the nasal component 342 and/or the second component 352 can include a separate housing configured to extend around the nasal component 342 and/or the second component 352 and be received by the nasal component housing 340.

Any of the features, components, and/or parts, of the head-mountable device 300 including the arrangements and configurations thereof shown in FIGS. 3A-3C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 3A-3C.

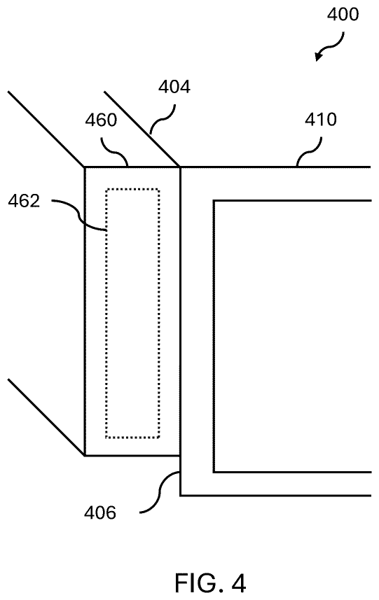

FIG. 4 illustrates a front close-up view of one example of a head-mountable device 400. The head-mountable device 400 can include a securement arm 404, a frame body 410, an optical frame 406, a frame component housing 460, and a frame component 462. The securement arm 404 can be substantially similar to the securement arms 104a-b. The frame body 410 can be substantially similar to the frame body 110, 210, and 310. The frame body 410 can be created using an injection molding process. The frame body 410 can define an internal cavity that is configured to receive internal components, an interconnect, or a combination thereof.

The optical frame 406 can be coupled to the frame body 410. In one example, the optical frame 406 can be defined by the frame body 410. The optical frame 406 can be integrated into the frame body 410. The optical frame 406 can be substantially similar to the optical frames 106a-b, 206, and 306.

The frame component 462 can be an internal component, such as power sources, batteries, processors, cameras, internal facing cameras, gyroscopes, lights, speakers, microphones, and the like. In one example, the frame component 462 can be an interconnect configured to electrically couple internal components of the frame body 410 to internal components of the securement arm 404. In one example, the frame component 462 can include an internal component and an interconnect. In one example, the frame component 462 can include an attachment mechanism configured to couple the securement arm 404 to the frame body 410. In one example, the frame component 462 can be sensitive to temperature, pressure, or a combination thereof.

The frame component housing 460 can be configured to couple to the frame body 410. In one example, the frame component housing 460 can be received by the frame body 410. The frame component housing 460 can be integrated into the frame body 410 during the creation of the frame body 410. The frame component housing 460 can be configured to pot one or more frame components 462 before coupling to the frame body 410. In one example, the frame component 462 can be coupled to an interconnect of the frame body 410, before the frame body 410 is created, and the frame component housing 460 can be integrated into the frame body 410 during the creation of the frame body 410. For example, the frame body 410 can be created using a low injection pressure overmolding process, an injection mold process, or other process, which encapsulates, or partially encapsulates the frame component housing 460. The frame component housing 460 can be configured to thermally insulate the frame component 462. In one example, the frame component housing 460 can be configured to protect the frame component 462 from pressure. For example, the frame component housing 460 can be configured to protect the frame component 462 during creation of the frame body 410. In one example, the frame component housing 460 can include a flowable material surrounding the frame component 462. The frame component housing 460 can be configured to create a boundary between the frame component 462 and the frame body 410.

Any of the features, components, and/or parts, of the head-mountable device 400 including the arrangements and configurations thereof shown in FIG. 4 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 4.

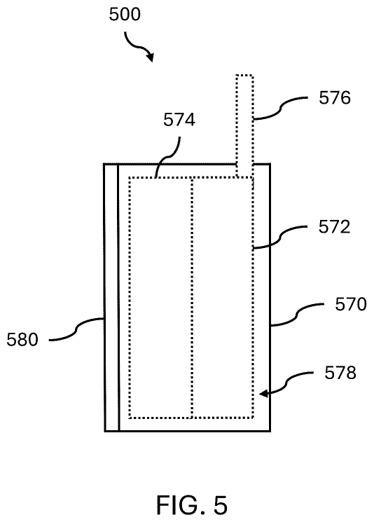

FIG. 5 illustrates a close-up cross-sectional view of one example of a head-mountable device 500. The head-mountable device 500 can include a nasal component housing 570.

The nasal component housing 570 can define an internal cavity 578. The nasal component housing 570 can be configured to receive one or more nasal components 572, 574. The nasal component housing 570 can be configured to couple to a frame body or an optical frame of the head-mountable device 500. In one example, the nasal component housing 570 can be received by the frame body or the optical frame. The nasal component housing 570 can be integrated into the frame body during the creation of the frame body. The frame nasal component housing 570 can be configured to pot one or more nasal components 572, 574 before coupling to the frame body.

In one example, the nasal component housing 570, or components thereof, can be coupled to an interconnect of the frame body, before the frame body is created, and the nasal component housing 570 can be integrated into the frame body or optical frame during the creation of the frame body. For example, the frame body can be created using a low injection pressure overmolding process, an injection mold process, or other process, which encapsulates, or partially encapsulates the nasal component housing 570. The nasal component housing 570 can be configured to thermally insulate the nasal components 572, 574. In one example, the nasal component housing 570 can be configured to protect the nasal component 572, 574 from pressure. For example, the nasal component housing 570 can be configured to protect the nasal components 572, 574 during creation of the frame body. In one example, the nasal component housing 570 can include a flowable material surrounding the nasal component 572, 574. The nasal component housing 570 can be configured to create a boundary between the nasal components 572, 574 and the frame body. The

The nasal component housing 570 can be configured to house nasal component 572, 574. In one example, the nasal component housing 570 can define an internal cavity 578 to house the nasal components 572, 574. The nasal components 572, 574 can include power sources, batteries, processors, cameras, internal facing cameras, gyroscopes, lights, speakers, microphones, a gyroscope, an inertial measurement unit, a printed circuit board, a combination thereof, and the like. The nasal components 572, 574 can be sensitive to temperature, pressure, or a combination thereof. In one example, the nasal components 572, 574 can be configured to couple together.

For example, one of the nasal components 572, 574 can be a flexible circuit board that is configured to couple the other nasal component 572, 574. In one example, the nasal components 572, 574 can be secured into the nasal component housing 570 with adhesive. In one example, adhesive can be added to the internal cavity 578 around the nasal components 572, 574.

In one example, nasal components 572, 574 can be coupled to an electrical interconnect or electrical flex 576, which can include a flexible electrical circuit or printed circuit. The flex 576 can be an electrical interconnect, or a portion of an electrical interconnection system. The flex 576 can extend from the nasal component housing 570. In one example, the flex 576 can be secured in position by the nasal component housing 570. The flex 576 can be configured to couple the nasal components 572, 574 to other internal components of the head-mountable device 500.

The nasal component housing 570 can include a cover 580. The cover 580 can define a boundary of the internal cavity 578 of the nasal component housing 570. The cover 580 can be configured to be attached to the nasal component housing 570 after the nasal components 572, 574 are added to the internal cavity 578. In one example, the cover 580 can be received in an aperture of the nasal component housing 570. The cover 580 can be adhered to the nasal component housing 570. In one example, the cover 580 can be transparent.

Any of the features, components, and/or parts, of the head-mountable device 500 including the arrangements and configurations thereof shown in FIG. 5 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 5.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, X® (formerly TWITTER®) ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A head-mountable device, comprising:
a frame defining:
a first portion; and
a housing, the housing defining an internal frame volume;
a display window coupled to the frame;
an internal component disposed within the internal frame volume, and
a material dam coupled to the first portion and defining a boundary between the internal frame volume and the first portion.

2. The head-mountable device of claim 1, wherein:
the frame comprises a first material; and
the material dam comprises the first material.

3. The head-mountable device of claim 1, wherein:
the frame comprises a first material; and
the material dam comprises a second material.

4. The head-mountable device of claim 1, wherein the internal component comprises at least one of a speaker, a charging module, a camera, a gyroscope, or an LED.

5. The head-mountable device of claim 1, further comprising an electrical interconnect extending from the internal component to a second component through the boundary.

6. The head-mountable device of claim 1, wherein the frame defines the housing proximal a nasal region or a temple region of a user donning the head-mountable device.

7. The head-mountable device of claim 1, further comprising a securement arm, wherein the housing is positioned between the frame and the securement arm.

8. The head-mountable device of claim 1, wherein the housing and the material dam define the internal volume configured to receive the internal component.

9. A head-mountable device, comprising:
a frame defining an internal component cavity and a channel extending toward the internal component cavity;
an optical module coupled to the frame;
an internal component configured to be received by the internal component cavity;
a dam separating the channel and the internal component cavity; and
a flex comprising a cantilever portion at a distal end of the flex;
wherein:
the flex extends through the channel;
the cantilever portion extends into the internal component cavity;
the cantilever portion is surrounded by the dam; and
the internal component is configured to couple to the cantilever portion.

10. The head-mountable device of claim 9, wherein the cantilever portion is configured to bend up to about 90 degrees relative to the dam.

11. The head-mountable device of claim 9, wherein the cantilever portion is configured to partially enclose the internal component within the internal component cavity.

12. The head-mountable device of claim 9, wherein the internal component is configured to electrically couple to the cantilever portion.

13. The head-mountable device of claim 9, wherein:
the internal component is a first internal component; and
the head-mountable device further comprises a second internal component coupled to the first internal component.

14. The head-mountable device of claim 9, wherein:
the dam comprises a first material; and
the channel is filled with the first material.

15. The head-mountable device of claim 9, further comprising a cover configured to couple to the internal component housing and define the internal cavity.

16. The head-mountable device of claim 9, wherein the cantilever portion comprises a circuit board.

17. A wearable display device, comprising:
a frame defining an internal channel;
an optical frame coupled to the frame;
an electrical interconnect extending through the channel;
a component housing configured to couple to the frame; and
an internal component disposed in the component housing and configured to electrically couple to the interconnect.

18. The wearable display device of claim 17, wherein the component housing comprises an insulating material.

19. The wearable display device of claim 17, wherein the component housing comprises:
an internal cavity configured to receive the internal component; and
a component interconnect configured to electrically couple the internal component to the electrical interconnect;
wherein the electrical interconnect extends from the internal cavity to an exterior of the component housing.

20. The wearable display device of claim 17, wherein the component housing comprises a cover configured to enclose the internal component within the component housing.
